(19) United States
(12) Patent Application Publication
(10) Pub. No.: US 2026/0155672 A1
(43) Pub. Date: Jun. 4, 2026

(54) Systems and Methods for a Charger with a Real Time Clock

(71) Applicant: Milwaukee Electric Tool Corporation, Brookfield, WI (US)

(72) Inventor: Jonathan E. Abbott, Milwaukee, WI (US)

(21) Appl. No.: 18/704,034

(22) PCT Filed: Oct. 26, 2022
(86) PCT No.: PCT/US2022/047883

§ 371 Date: Apr. 23, 2024

Related U.S. Application Data
(60) Provisional application No. 63/272,588, filed on Oct. 27, 2021.

(51) Int. Cl. H02J 7/90; H02J 7/44; H02J 7/45; H02J 7/70

(52) U.S. Cl. CPC H02J 7/975; H02J 7/44; H02J 7/45; H02J 7/751

(57) ABSTRACT

A power tool battery charger for determining time information for use in controlling charging of a power tool battery pack may include a battery pack interface, a controller and a memory. The battery pack interface is configured to receive a power tool battery pack and provide charging current to the power tool battery pack. In some embodiments, the power tool battery charger also includes an input configured to receive a set of data. The controller may be coupled to the input and configured to analyze the set of data to determine time information. In some embodiments, the power tool battery charger includes at least one sensor configured to generate a set of data. The controller may be coupled to the at least one sensor and configured to analyze the set of data to determine time information. The memory is coupled to the controller and configured to store the time information.

### RELATED APPLICATIONS

The present application is based on and claims priority from U.S. patent application Ser. No. 63/272,588, filed on Oct. 27, 2021, the entire disclosure of which is incorporated herein by reference.

### SUMMARY

In accordance with an embodiment, a charger is provided for determining time information for use in controlling charging of a power tool battery pack. The charger includes a battery pack interface, an input, a controller and a memory. The battery pack interface can be configured to receive a power tool battery pack and to provide charging current to the power tool battery pack. The input can be configured to receive a set of data. The controller is coupled to the input and can be configured to analyze the set of data to determine time information. The memory is coupled to the controller and can be configured to store the time information.

In accordance with another embodiment, a method for determining time information for a charger for a power tool battery pack includes receiving a set of data using an input of the charger, analyzing the set of data using a controller of the charger to determine time information, and storing the time information in a memory.

In accordance with another embodiment, a charger is provided for determining time information for use in controlling charging of a power tool battery pack. The charger includes a battery pack interface, at least one sensor, a controller, and a memory. The battery pack interface can be configured to receive a power tool battery pack and provide charging current to the power tool battery pack. The at least one sensor can be configured to generate a set of data. The controller is coupled to the at least one sensor and can be configured to analyze the set of data to determine time information. The memory is coupled to the controller and can be configured to store the time information.

In some examples, the at least one sensor is one or more of a light sensor, a motion sensor, a humidity sensor, and a temperature sensor. In some examples, the at least one sensor is a light sensor and the set of data includes ambient light detected by the light sensor and the time information includes an approximate time of day determined based on the detected ambient light. In some examples, set of data includes detection of a presence of a power tool battery pack in a charger and the time information includes one or more time periods during which the power tool battery pack is in use. In some examples, the charger further includes a real time clock configured to set a time using the time information and to maintain a current time for the charger. In some examples, the charger further includes an internal battery coupled to the real time clock. In some examples, the charger further includes an AC power interface configured to be connected to an AC power source, wherein the internal battery is configured to be recharged when the AC power interface is connected to the AC power source. In some examples, the controller is further configured to control charging of the power tool battery pack based on the time information.

In accordance with another embodiment, a method for determining time information for a charger for a power tool battery pack includes receiving a set of data from at least one sensor, analyzing the set of data, using a controller of a charger to determine time information, and storing the time information in a memory.

In some examples, the at least one sensor is one or more of a light sensor, a motion sensor, a humidity sensor, and a temperature sensor. In some examples, the at least one sensor is a light sensor and the set of data includes ambient light detected by the light sensor and the time information includes an approximate time of day determined based on the detected ambient light. In some examples, set of data includes detection of a presence of a power tool battery pack in a charger and the time information includes one or more time periods during which the power tool battery pack is in use. In some examples, the charger further includes a real time clock configured to set a time using the time information and to maintain a current time for the charger. In some examples, the charger further includes an internal battery coupled to the real time clock. In some examples, the charger further includes an AC power interface configured to be connected to an AC power source, wherein the internal battery is configured to be recharged when the AC power interface is connected to the AC power source. In some examples, the controller is further configured to control charging of the power tool battery pack based on the time information.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1A illustrates an example of a power tool battery charger in accordance with an embodiment;

FIG. 1B illustrates an example of a power tool battery pack in accordance with an embodiment;

FIG. 2 is a block diagram of a charging system for a power tool in accordance with an embodiment;

FIG. 3 is a block diagram of a charger for determining time information for use in controlling charging of a power tool battery pack in accordance with an embodiment;

FIG. 4 illustrates a method for determining time information for a charger for a power tool battery pack in accordance with an embodiment;

FIG. 5 is a block diagram of a charger for determining time information for use in controlling charging of a power tool battery pack in accordance with an embodiment; and

FIG. 6 illustrates a method for determining time information for a charger for a power tool battery pack in accordance with an embodiment.

### DETAILED DESCRIPTION

A charger for a power tool battery pack may utilize time data or information (e.g., time of day, day of the week, particular date, etc.) to perform certain features and operations related to charging and maintenance of a power tool battery pack. For example, time data information may be used to determine when a charger should perform certain scheduled actions or to collect time-stamped data. However, internal clocks of a charger or a controller of a charger may not provide or have access to real time clock data or information. Rather, an internal clock of a charger may only provide a time since the charger was last plugged in to a power source rather than a true physical time or date. Accordingly, it may be difficult to optimize battery charging and other charger features.

Described herein are various systems and methods for determining time information for a charger for a power tool battery pack. In some embodiments, a power tool battery charger may be configured to receive data using an input of the charger such as, for example, a user interface or communication system (e.g., a transceiver), and the data may be used to determine time information. In one example, a user may provide data to the power tool battery charger via the user interface. In another example, the power tool battery charger may receive data from an external time source (e.g., a battery pack, a server, a smartphone, etc.) via the communication system. In some embodiments, the power tool battery charger may be configured to receive data using an internal source such as one or more sensor(s), for example, a motion sensor, a light sensor, a temperature sensor, a humidity sensor, etc. In some embodiments, the time information may include a time and date and may be used to set an internal clock in the power tool battery charger with a true physical time. In some embodiments, the time information may include, for example, when a user might need a battery charged, use patterns of a user's batteries, etc. In some embodiments, the time information may be utilized by the power tool battery charger to perform certain features and operations related to, for example, charging and maintenance of a power tool battery pack.

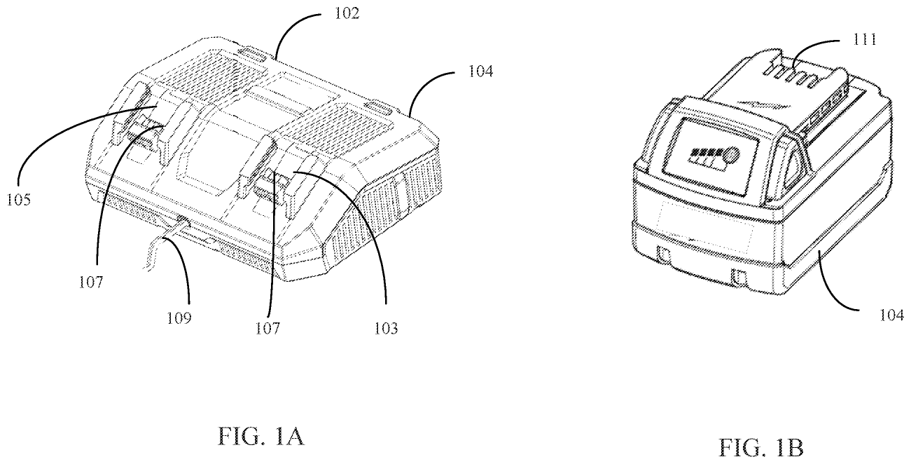

FIG. 1A illustrates an example of a power tool battery charger in accordance with an embodiment. As illustrated, the charger 102 includes two charging docks 103 and 105. Each charging dock 103, 105 is configured to receive and provide charging current to one power tool battery pack at a time (e.g., battery pack 104 shown in FIG. 1B) and includes a battery pack interface such as, for example, terminals 107 which may be, for example, power and/or communication terminals. To receive a power tool battery pack, the power tool battery charger 102 may electrically and mechanically interface with the power tool battery pack. Accordingly, the power tool battery charger 102 is configured to electrically and mechanically interface with a power tool battery pack via each respective charging dock 103, 105. Electrically interfacing may include electrical or power terminals of the power tool battery charger 102 and electrical terminals of the battery pack contacting one another, may include a wireless connection for wireless power transfer (e.g., between inductive or capacitive elements of the battery pack and power tool battery charger 102), or a combination thereof. In some embodiments, each charging dock 103, 105 may also include one or more communication terminals that interface with respective communication terminals of the battery pack. In some embodiments, the charger 102 may wirelessly communicate with battery packs received in each dock 103, 105 (or otherwise nearby or within wireless communication range of the charger 102). Mechanical interfacing may include the battery pack being received in a receptacle of the power tool battery charger 102, a mating of physical retention structures of the battery pack and power tool battery charger 102 (e.g., rails and grooves), or a combination thereof. In some examples, the power tool battery charger 102 includes fewer or additional charging docks. In some embodiments, the power tool battery charger 102 electrically interfaces with a battery pack for wireless charging and/or wireless communication, but does not mechanically interface (e.g., the pack may be nearby, but not physically contacting the charger). In some examples, the power tool battery charger 102 is configured to receive and charge power tool battery packs (e.g., pack 104 shown in FIG. 1B) having a nominal voltage of approximately 18 volts, a nominal voltage between 16 volts and 22 volts, or another amount. In some embodiments, the power tool battery charger 102 may receive power from an external power source, for example, an AC power source, through the AC power interface that may, for example, include an AC power cord 109. The AC power cord 109 may be connectable to various types of AC power supplies, such as, for example, an AC wall outlet connected to a utility grid or an AC outlet of an inverter (e.g., powered by a gas engine-generator, a photovoltaic (PV) array, chemically-powered generator, etc.). The charger 102 may further include a housing 104 supporting components of the charger 102 and defining an internal volume housing internal components of the charger 102 (e.g., the circuitry thereof).

FIG. 1B illustrates an example of a power tool battery pack in accordance with an embodiment. Power tool battery pack 104 is configured to be received and charged by a power tool battery charger (e.g., charger 102 shown in FIG. 1A) and may include a charger interface such as, for example, terminals 111 which may be, for example, power or communication terminals. Battery pack 104 is further configured to be received by and provide power to a power tool. To be received by a charger or power tool, battery pack 104 may electrically and mechanically interface with the charger and (at a different time) with a power tool. As mentioned above, electrically interfacing may include electrical or power terminals 111 of the power tool battery 104 and electrical terminals (e.g., terminals 107 shown in FIG. 1A) of the power tool battery charger contacting one another, may include a wireless connection for wireless power transfer (e.g., between inductive or capacitive elements of the battery pack 104 and the power tool battery charger), or a combination thereof. In some embodiments, the battery pack 104 may also include one or more communication terminals that interface with respective communication terminals of the power tool battery charger. In some examples, the power tool battery pack 104 has a first nominal voltage of approximately 18 volts, of between 16 volts and 22 volts, or another amount. In some embodiments, to achieve additional capacity the battery pack 104 may include an additional, set of battery cells. For example, the pack 104 may include two or more sets of series connected battery cells, with each set being connected in parallel to the other set(s) of cells.

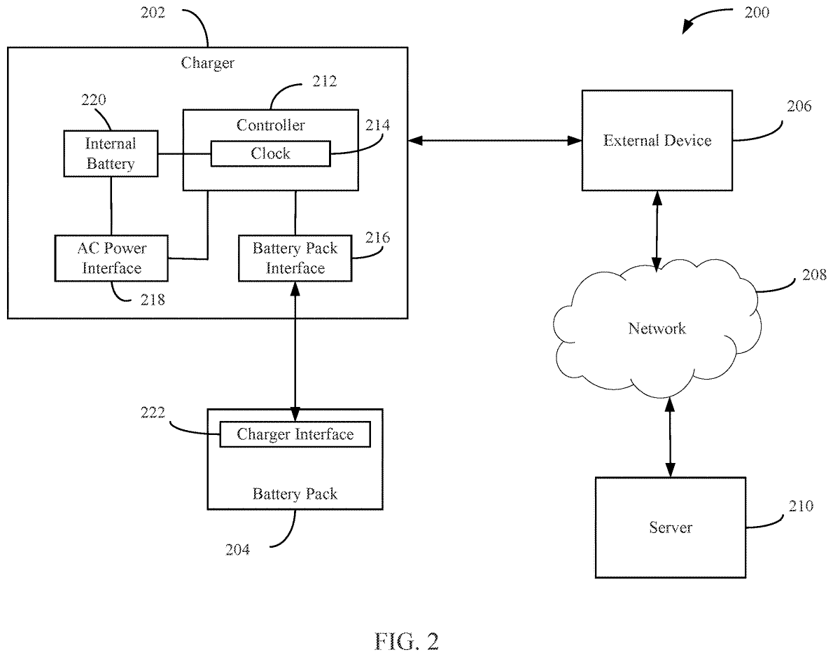

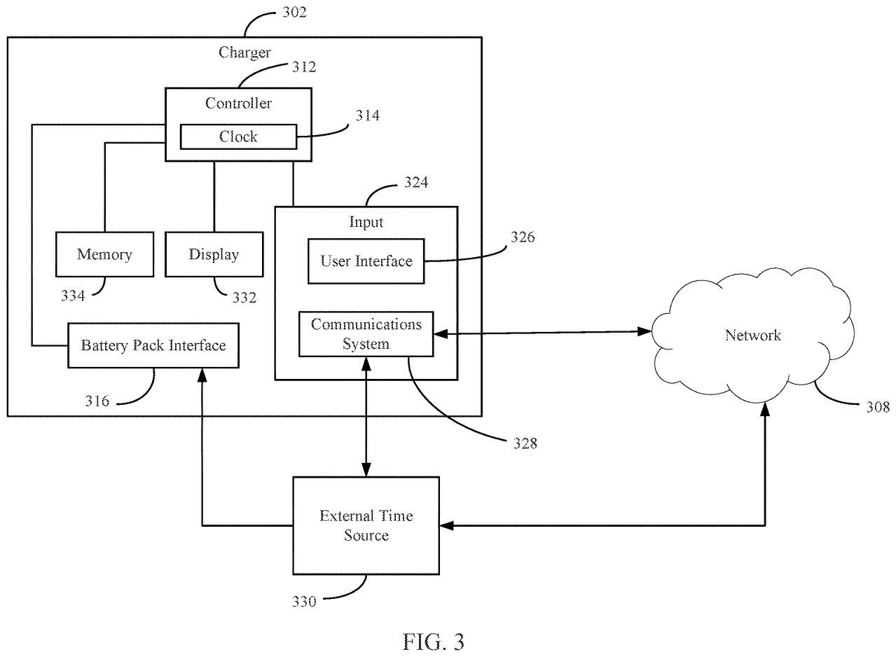

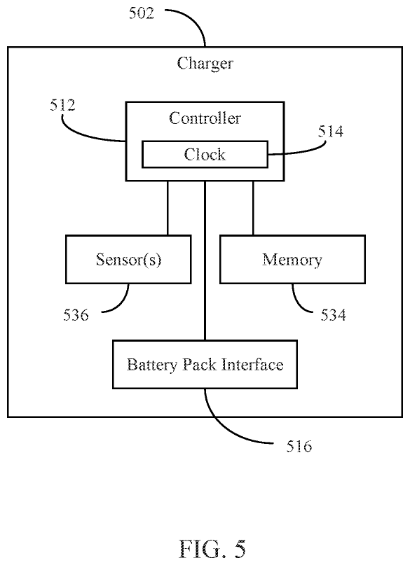

FIG. 2 is a block diagram of a charging system 200 for a power tool in accordance with an embodiment. The charging system 200 includes a power tool battery charger 202, an external device 206, a network 208, and a server 210. The power tool battery charger 202 (e.g., charger 102 shown in FIG. 1A) may be configured to receive and provide charging current to at least one power tool battery pack 204 (e.g., battery pack 104 shown in FIG. 1B). The power tool battery charger 202 may include an electronic controller 212, a battery pack interface 216, an AC power interface 218 and an internal battery 220. In some embodiments, power tool battery charger 202 may also include a communication system (e.g., communication system 328 shown in FIG. 3), a display (e.g., display 332 shown in FIG. 3), a memory (e.g., memory 334 shown in FIG. 3), sensor(s) (e.g., sensor(s) 536 shown in FIG. 5), and other elements that are not shown in FIG. 2 to simplify the illustration.

The controller 212 can include an electronic processor and a memory that communicate over one or more control buses, data buses, etc. The electronic processor can be configured to communicate with the memory to store data and retrieve stored data. The electronic processor can be configured to receive instructions and data from the memory and execute, among other things, the instructions. In particular, the electronic processor may execute instructions stored in the memory to carry out the functionality of the controller 212 described herein. The memory can include read-only memory (ROM), random access memory (RAM), other non-transitory computer-readable media, or a combination thereof. The memory can include instructions for the electronic processor to execute. The instructions can include software executable by the electronic processor to enable the controller 212 to, among other things, carry out the functionality of the controller 212 described herein.

The controller 212 may be configured to perform and control various features and operations of the charger 202, for example, related to charging and maintenance of a battery pack 204. In some embodiments, the controller 212 may be configured to perform one or more of the methods described herein. For example, the controller 212 may be configured to implement the various features described herein with respect to FIGS. 2-6.

In some embodiments, the power tool battery charger 202 may also include various sensors and devices that collect usage information or data, during the operation of the power tool battery charger 202. The usage information, or data, may alternatively be referred to as operational information, or data, of the power tool battery charger 202, and refers to, for example, data regarding the operation of the power tool battery charger 202 (e.g., current, position, acceleration, temperature, usage time, humidity, and the like), the operating mode of the power tool battery charger 202 (e.g., operation time in each mode, frequency of operation in each mode, and the like), conditions encountered during operation, and other aspects (e.g., state of charge of the battery, and the like).

In the illustrated embodiment, the power tool battery charger 202 communicates with the external device 206. The external device 206 may include, for example, a smartphone, a tablet computer, a cellular phone, a laptop computer, a smart watch, and the like. The power tool battery charger 202 communicates with the external device 206, for example, to transmit at least a portion of the usage information for the power tool battery charger 202, to receive configuration information for the power tool battery charger 202, or a combination thereof. In some embodiments, the external device 206 may include a short-range transceiver to communicate with the power tool battery charger 202, and a long-range transceiver to communicate with the server 210. In the illustrated embodiment, the power tool battery charger 202 also includes a transceiver (e.g., included as part of a communication system 328 shown in FIG. 3) to communicate with the external device 206 via, for example, a short-range communication protocol such as BLUETOOTH®. In some embodiments, the external device 206 bridges the communication between the power tool battery charger 202 and the server 210. For example, the power tool battery charger 202 transmits operational data to the external device 206, and the external device 206 forwards the operational data from the power tool battery charger 202 to the server 210 over the network 208. Additionally or alternatively, the server 210 may transmit data to the external device 206, via the network 208, and then the external device 206 may forward the data to the power tool battery charger 202.

The network 208 may be long-range wireless network, such as the Internet, a local area network (“LAN”), a wide area network (“WAN”), or a combination thereof. In other embodiments, the network 208 may be a short-range wireless communications network, and in yet other embodiments, the network 208 may be a wired network using, for example, one or more USB or Ethernet cables. Similarly, the server 210 may transmit information to the external device 206 to be forwarded to the power tool battery charger 202. In some embodiments, the power tool battery charger 202 is equipped with a long-range transceiver instead of or in addition to the short-rage transceiver. In such embodiments, the power tool battery charger 202 communicates directly with the server 210. In some embodiments, the power tool battery charger 202 may communicate directly with both the server 210 (e.g., via the network 208, but bypassing the external device 206) and the external device 206. In such embodiments, the external device 206 may, for example, generate a graphical user interface to facilitate control and programming of the power tool battery charger 202, while the server 210 may store and analyze larger amounts of operational data for future programming or operation of the power tool battery charger 202. In other embodiments, however, the power tool battery charger 202 may communicate directly with the server 210 without utilizing a short-range communication protocol with the external device 206.

In some embodiments, the server 210 may include a server electronic control assembly (not shown) having a server processor, a server memory, a transceiver, and a machine learning controller. The transceiver allows the server 210 to communicate with the power tool battery charger 202, the external device 206, or both. The server processor receives usage data from the power tool battery charger 202 (e.g., via the external device 206), stores the received usage data in the server memory, and, in some embodiments, uses the received usage data for constructing, training, or adjusting the machine learning controller. The machine learning controller implements a machine learning program, algorithm or model, or can additionally or alternatively implement other artificial intelligence programs, algorithms, or models. In some embodiments, the machine learning controller is configured to construct a model (e.g., building one or more algorithms) based on example inputs, which may be done using supervised learning, unsupervised learning, reinforcement learning, ensemble learning, active learning, transfer leaning, or other suitable learning techniques for machine learning and/or artificial intelligence programs, algorithms, or models. As a non-limiting example, the machine learning controller can construct a machine learning program, algorithm, or model using supervised learning techniques, or alternatively can access a machine learning program, algorithm, or model previously constructed using supervised learning techniques. The machine learning algorithm may be configured to implement various different types of machine learning or other artificial intelligence algorithms or models. For example, the machine learning controller may implement decision tree learning, associates rule learning, artificial neural networks, recurrent neural networks, long short-term memory models, inductive logic programming, support vector machines, clustering, Bayesian networks, reinforcement learning, representation learning, similarity and metric learning, sparse dictionary learning, genetic algorithms, and k-nearest neighbors (“KNN”) classifiers.

The machine learning controller can be programmed and trained to perform a particular task. In some embodiments, the power tool battery pack charger 202 may include a machine learning controller (e.g., controller 212 may be implemented as or include a machine learning controller) similar to the machine learning controller described above with respect to server 210. In some embodiments, the machine learning controller of the power tool battery charger 202 may include a static machine learning controller that can, for example, be received by the power tool battery charger 202 from the server 210 over the network 208. In some embodiments, the power tool battery charger 202 receives the static machine learning controller during manufacturing, while in other embodiments, a user of the power tool battery charger 202 may select to receive the static machine learning controller after the power tool battery charger 202 has been manufactured and, in some embodiments, after operation of the power tool battery charger 202.

In some embodiments, the machine learning controller of the power tool battery charger 202 may include an adjustable machine learning controller (e.g., controller 212 may be implemented as or include an adjustable machine learning controller) instead of a static machine learning controller. An adjustable machine learning controller of the power tool battery charger 202 may receive the machine learning program, algorithm, or model from the server 210 over the network 208. Unlike the static machine learning controller, the server 210 may transmit updated versions of the machine learning program, algorithm, or model to the adjustable machine learning controller to replace previous versions. In some embodiments, the machine learning controller of the power tool battery charger 202 may include a self-updating machine learning controller (e.g., the controller 212 may be implemented as a self-updating machine learning controller). The self-updating machine learning controller is first loaded on the power tool battery charger 202 during, for example, manufacturing. The self-updating machine learning controller may update and re-train itself. In some embodiments, the self-updating machine learning controller may be re-trained on the power tool battery charger 202, by the server 210, or with a combination thereof.

In some embodiments, the external device 206 may include a machine learning controller. In some embodiments, the machine learning controller is similar to the machine learning controller discussed above with respect to server 210 and controller 212. In such embodiments, the machine learning controller may, for example, receive the usage information from the power tool battery charger 202 and generate recommendations for future operations of the power tool battery charger. In some embodiments, the battery pack 204 may include a machine learning controller. Although not illustrated, the battery pack 204 may, in some embodiments, communicate with the external device 206, the server 210, or a combination thereof, through, for example, the network 208 or a direct connection. Additionally or alternatively, the battery pack 204 may communicate with a power tool battery charger, such as a power tool battery charger 202, to which the battery pack 204 is connected, or may communicate with a power tool (not shown) attached to the battery pack. The machine learning controller of the battery pack 204 may be similar to any of the machine learning controllers described above. In one embodiment, the machine learning controller controls operation of the battery pack 204.

As mentioned above, the power tool battery charger 202 also includes a battery pack interface 216, an AC power interface 218, and an internal battery 220. The battery pack interface 216 may be configured to selectively receive and interface with a power tool battery pack 204. The battery pack interface 216 may include one or more power terminals and, in some cases, one or more communication terminals that interface with respective power and/or communication terminals of the power tool battery pack 204. For example, a charger interface 222 of the battery pack 204 may include power and/or communication terminals to interface with the respective power and/or communication terminals of the battery pack interface 216. The power tool battery pack 204 may include one or more battery cells of various chemistries, such as lithium-ion (Li-Ion), nickel cadmium (Ni-Cad), and the like. The power tool battery pack 204 and/or the power tool battery charger 202 may further include a mechanical interface to prevent unintentional detachment. The power tool battery pack 204 may further include a pack electronic controller (pack controller) including a processor and a memory. The pack controller may be configured similarly to the electronic controller 212 of the power tool battery charger 202. The pack controller may be configured to regulate charging and discharging of the battery cells, and/or to communicate with the electronic controller 212. In some embodiments, the power tool battery pack 204 further includes a transceiver (not shown) coupled to the pack controller. Accordingly, the pack controller, and thus the power tool battery pack 204, may be configured to communicate with other devices.

The power tool battery charger 202 may receive power from an external power source through the AC power interface 218. In some embodiments, the external power source includes an AC power source. In such embodiments, the AC power interface may include an AC power cord that is connectable to, for example, an AC outlet. The AC power interface 218 is coupled to the controller 212 and the internal battery 220. The AC power interface 218 may condition power received from an external power source (e.g., rectify, filter, etc.) and transmit power received from the external power source to the controller 212 as well as other elements of the power tool battery charger 202. The AC power interface 218 also may provide power to the internal battery 220 to, for example, recharge the internal battery 220. For example, the AC power interface may include an AC/DC rectifier (and, optionally, a DC/DC converter) to convert the received AC power to DC power level appropriate for charging the internal battery 220 (e.g., to the nominal DC voltage level of the internal battery 220). In some examples, a battery pack 204 coupled to the charger 202 may provide power to the charger 202 to recharge the internal battery 220 (e.g., when AC power at the AC power interface 218 is not present). For example, the charger 202 may include a DC/DC converter to convert DC power from the battery pack 204 to a DC power level appropriate for charging the internal battery 220. The internal battery 220 (or back-up power source) may be used to, for example, provide power to various elements of the power tool battery charger 202 when the AC power interface 218 is not connected to an external power source, for example, when an AC power cord is not connected to an AC power source. For example, the internal battery 220 may be coupled to a clock 214 of the controller 212 to provide power to the clock 214. Accordingly, the clock 214 may continue to run (e.g., track time, date, etc.) even when the power tool battery charger 202 is not coupled to an external power source. In some embodiments, the internal battery may be, for example, a coin cell (e.g., a 1.5 V coin cell battery, a 3 V coin cell battery, or the like). In some examples, in addition or alternative to the AC power interface 218, a DC power interface is provided to receive and condition DC power from one or more DC sources. The conditioned DC power may be provided to the controller 212 and other components of the charger 202, similar to the conditioned AC power from the AC power interface 218 described above. The one or more DC sources coupled to the DC power interface may be, for example, solar panel(s), battery power bank, DC output of a vehicle, DC output of an engine-generator, and the like. In some examples, the DC power interface may include a standardized DC port, such as a USB® port, via which the DC power interface is coupled to the DC source.

In some embodiments, clock 214 may be a real time clock (RTC). The RTC may be configured to increment and keep time independently of the other power tool battery charger components. In contrast to other clock types, a RTC indicates a time of day (e.g., in a particular time zone) based on a standard time scale, such as Coordinated Universal Time (UTC). The RTC may be used to, for example, time stamp the operational data from the power tool battery charger 202. In some embodiments, the clock 214 (e.g., an RTC) may be integrated in the controller 212 as shown or the clock 214 may be implemented as a separate chip or integrated circuit. In some embodiments, the clock 214 includes a crystal or oscillator that generates a periodic signal enabling the clock 214 to keep time. In some embodiments, the clock 214 uses an AC input to the charger 202 (e.g., an AC signal at the AC power interface 218) to keep time. For example, the clock 214 may monitor the AC signal received at the AC power interface 218, which may be a periodic alternating signal. For example, when the AC signal is a 60 Hz signal, the clock 214 may increment one second for every 60 periods of the AC signal, may increment 0.50 seconds for every 30 periods, may increment 0.25 seconds for every 15 periods, or at another rate to achieve a desired precision. In some cases, such an AC signal may alternate with a more consistent frequency then some oscillators and, thus, may enable the clock 214 to be more accurate.

In some embodiments, the clock 214 uses both a crystal or oscillator that generates a periodic signal and a periodic AC power signal that is input to the charger 202 to keep time. For example, the charger 202 may determine and store correctional parameters based on a frequency of the AC power signal (e.g., by tracking the error or difference between the crystal or oscillator frequency and the frequency of the AC power signal). The charger 202 may detect the frequency of the AC power signal (e.g., 50 Hz or 60 Hz depending on locality) using the periodic signal of the crystal or oscillator (e.g., by detecting zero-crossings of the AC signal over a certain period of time). In some embodiments, the charger 202 may receive an indication (e.g., from the external device 206 or a user interface on the charger 202) of the frequency of the AC power signal. In some embodiments, the clock 214 may default to using the frequency of the AC signal to increment and keep time for precision time-keeping when the charger 202 determines that the AC signal is available, and may use the crystal or oscillator to keep time when the charger 202 determines that the AC signal is not available. In some embodiments, the clock 214 may use the crystal or oscillator-based time as a basis for timing of most charging functions at a microscale level, and may use the AC input-based time at a macroscale level as a basis for controlling higher level decisions (such as generally how and when to charge a battery pack).

In some embodiments, the AC signal encodes other information in addition to the relative time information indicated by the periodic nature of the main wave frequency of the AC signal. For example, particular variations or modulations (e.g., in frequency, amplitude, or the like) of a power signal enables power line communication (PLC). In particular, data can be encoded in these modulations of the AC signal by a transmitting device, resulting in a data signal overlayed on or embedded in the AC signal. A receiving device may receive the AC signal with modulations and decode the modulations to determine the transmitted data. Accordingly, in some examples, a charger 202 may receive and/or transmit time information to devices using these modulations, such as a time of day based on a standard time scale. The other device in communication with the charger 202 and providing time information may be, for example, a device of a power company or other third party, or may be another power tool device (e.g., a charger coupled to the same AC circuit as the charger 202). This other device may, in some examples, serve as the external device 206 or external time source 330 (FIG. 3) described below. Communication over power lines can include zero line crossing and noise propagation.

In some embodiments, separate from the clock 214, the controller 212 may also include a crystal or oscillator that provides a clock signal to components of the charger 202 (e.g., to the controller 212 to regulate processor operations, memory operations, and/or external communications, etc.).

The power tool battery charger 202 may be configured to obtain data from various sources that may be used to, for example, set the clock 214 (e.g., an RTC) and determine time information that may be used to perform various functions of the power tool battery charger 202 including, for example, charging of a battery pack 204. FIG. 3 is a block diagram of a charger for determining time information for use in controlling charging of a power tool battery pack in accordance with an embodiment. Power tool battery charger 302 includes a controller 312, a clock 314, a battery pack interface 316, an input 324, a display 332 and a memory 334. The power tool battery charger 302 is similar to that of power tool battery charger of FIG. 2, with like elements being assigned like numbers plus 100 (e.g., the description of the controller 212 of FIG. 2 provided above similarly applies to the controller 312 of FIG. 3, except for any differences noted). The power tool battery charger 302 may similarly be configured to receive and provide charging current to at least one power tool battery pack (not shown). Other components of the power tool battery charger 302 (e.g., an AC power source and an internal battery as shown in FIG. 2) are not shown in FIG. 3 to simplify the illustration, but may be present in the charger 302 and function similarly as in the charger 202. The input 324 includes a user interface 326 and a communication system 328. In some embodiments, the input 324 includes the user interface 326, and not the communication system 328. In other embodiments, the input 324 includes the communication system 328, but not the user interface 326.

In some embodiments, the user interface 326 is coupled to the controller 312 and may be configured to receive data (e.g., time and date information) from a user that may then be provided to the controller 312. In some embodiments, the user interface 326 is a graphical user interface. The user interface 326 may include or be coupled to a display 332. In one example, display 332 includes a digital display of the time or date. In some embodiments, the user interface 326 may include manually manipulateable input devices, such as buttons, knobs, levers, etc. Accordingly, the user interface 326 may, for example, allow a user to push a button, turn a knob, etc., to alter the time and/or date. In some embodiments, the user interface 326 may be configured to allow a user to unplug and replug in the power tool battery charger 302 (e.g., from/to an external power source) in quick succession to indicate a “start” or “end” time.

In some embodiments, the power tool battery charger 302 may receive data from an external time source 330 that is in communication with the power tool battery charger 302. In an embodiment, the external time source 330 may be a power tool battery pack (e.g., power tool battery pack 204 shown in FIG. 2). In some embodiments, the power tool battery charger 302 may receive data from or send data to the power tool battery pack via the battery pack interface 316. For example, as described above with respect to the battery pack interfaces of FIGS. 1A-2, the battery pack interface 316 may include one or more communication terminals. In an embodiment, the power tool battery pack may obtain, for example, time and date information, from a power tool. For example, the power tool battery pack may be connected to a power tool to obtain data or may communicate with the power tool wirelessly. In some embodiments, power tool battery pack may be a wireless Internet of Things (IoT) battery. Accordingly, the wireless IoT battery may receive the time or date information from an outside source (e.g., a power tool). The wireless IoT battery may also communicate time or date information to the power tool battery charger 302 wirelessly, or via the battery pack interface 316.

In some embodiments where the power tool battery pack has a communication device such as a transceiver, the power tool battery charger 302 may communicate with the power tool battery pack using the communication system 328. The communication system 328 may be configured to communicate with and receive data (e.g., time and date information) from an external time source 330 such as the power tool battery pack. In some embodiments, the communication system 328 may include a transceiver and a processor. The communication system 328 may be configured to communicate wirelessly using a wireless communication protocol, for example, cellular, Wi-Fi™, BLUETOOTH®, etc. The communication system 328 may communicate directly with the external time source 330 or may receive data from the external time source 330 over a network 308. The communication system 328 may provide the received data to the controller 312. In some embodiments, the external time source 330 may be, for example, a server (e.g., server 210 show in FIG. 2) or an external device (e.g., external device 206) such as a cellular phone, a smartphone, a smart watch, tablet, laptop, etc.

In some embodiments, the communication system 328 may include a global navigation satellite system (GNSS) receiver or device that is configured to receive signals from an external time source 330, namely, GNSS satellites and/or land-based transmitters, etc. The signals received from the GNNS satellites may include data such as time and date information. Determining time and date information from such signals may be readily performed when the charger 302 is outside or otherwise is able to receive such signals. However, in some scenarios, the reliability of such signals for time and date information may be reduced (e.g., when the charger 302 is indoors) and the time to receive and calculate the time and data information from such signals may be longer than desired. Such reliability and delays to determine a time and date may not be present in other techniques described herein.

Memory 334 may include read-only memory (ROM), random access memory (RAM), other non-transitory computer-readable media, or a combination thereof. The memory 334 may also include instructions for a processor of the controller 312 to execute. The controller 312 may be configured to communicate with the memory 334 to store data and retrieve stored data. Although shown separate from the controller 312, the memory 334 may be incorporated into the controller 312 in some examples.

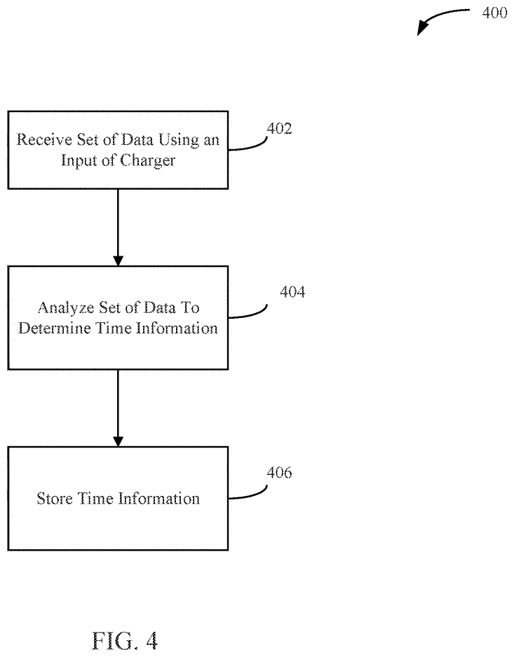

FIG. 4 illustrates a process 400 for determining time information for a charger for a power tool battery pack in accordance with an embodiment. The process 400 illustrated in FIG. 4 is described below as being carried out by the power tool battery charger 302 as illustrated in FIG. 3. However, in some embodiments, the process is implemented by another power tool battery charger having additional, fewer, and/or alternative components. Additionally, although the blocks of the process are illustrated in a particular order, in some embodiments, one or more of the blocks may be executed partially or entirely in parallel, may be executed in a different order than illustrated in FIG. 4, or may be bypassed.

In block 402, a power tool battery charger 302 receives a set of data using an input 324 of the power tool battery charger 302. The set of data may include, for example, time information (e.g., the time or the date and time of a particular time zone, such as Greenwich Mean Time (GMT) or another time zone). In some embodiments, the input 324 may be a user interface 326 that may include display or touch screen display presenting a graphical user interface and/or input device(s) such as buttons, knobs, levers, etc. to allow a user to enter the set of data. For example, via a virtual keypad on a graphical user interface of the user interface 326, a user may enter Sep. 1, 2021, into a date field of the graphical user interface, and 11:22 am (GMT) into a time field of the graphical user interface. In some embodiments, the input 324 may be a communication system 328 that is configured to communicate with and receive data from an external time source 330 (e.g., a power tool battery pack, a server, a cellular phone, a smartphone, a satellite, etc.), as described above with respect to FIG. 3. Alternatively, the set of data may be received from a power tool battery pack (serving as the external time source 330) via a battery pack interface (e.g., the battery pack interface 316, where the battery pack interface 316 is considered part of the communication system 328 of the charger 302). Regardless of the manner in which the set of data is provided to the input 324, the input 324 may then provide the set of data to the controller 312, and the controller 312 may receive the set of data from the input 324. In the case of the set of data being received by the communication system 328, in block 402, the communication system 328 may receive the set of data from the external time source 330 as a series of RF signals in a wireless communication according to a particular protocol (e.g., Bluetooth, Wi-Fi, LORA, Helium, CAT-M1, etc.). The communication system 328 may translate the received signals into digital data packets according to the protocol, where the digital data packets include a payload containing the set of data. In some examples, the wireless communication implemented by the communication system 328 and the external time source 330 may include transmission of time-of-day information as part of the wireless communication protocol. In such examples, the set of data received in block 402 may be or include this time-of-day information. In the case of the set of data being received by the user interface 326, the user interface 326 may output analog or digital signals to the controller 312 indicative of user input and, accordingly, of the set of data. In the case of the set of data being received by the battery pack interface 316, the battery pack interface 316 may output (or simply forward) analog or digital signals received from the battery pack that are indicative of the set of data.

In block 404, the received set of data is analyzed to determine time information such as, for example, time, date, etc. The received set of data may be analyzed using, for example a controller 312 of the power tool battery charger 302. For example, the data set may explicitly include or set forth the time and/or date (e.g., in the Greenwich Mean Time (GMT) time zone or another time zone). The power tool battery charger 302 (e.g., the controller 312) may then parse, unpack, decode, decrypt, or otherwise translate the data set (e.g., according to a protocol by which the data set was transmitted) to extract the time information. At least in some embodiments, the controller 312 may employ communication techniques that are standard for the protocol used to transmit the data set to extract the time information from the received set of data.

In block 406, the determined time information may be stored, for example, in a memory. For example, the controller 312 may store the time information in the memory 334 or another memory associated with clock 314. The stored time information may be used to, for example, set a clock 314 of the power tool battery charger 302 and to perform various functions of the power tool battery charger 302 including, for example, charging of a battery pack. The controller 312 may also communicate the time information to a connected battery pack coupled to the charger 302. The battery pack, in turn, may update its time information to this communicated time information. In some examples, the battery pack may store the received time information as a potential time information, evaluate the time information (e.g., take a weighted average of the time information), and selectively determine, based on the evaluation, to update its time information based on the received time information or reject the received time information. In some examples, the battery pack may provide the time information (potentially incremented to account for the passage of time since reception by the battery pack) to other power tool devices, such as power tool devices to which the battery pack is coupled. Accordingly, the time information determined by the charger controller 312 may be propagated through a collection of power tools through one or more battery packs serving as an intermediary with power tool devices.

In some embodiments of the process 400, after storing the time information, the controller 312 is configured to maintain a current time for the charger 302 via the clock 314, which may be a real time clock. For example, the clock 314 may have a crystal or oscillator that generates a clock signal at regular, known intervals, which a processor of the clock 314 may track or count. Based on the tracked clock signal (e.g., after a predetermined number of rising or falling edges of the clock signal), the processor of the clock 314 may increment the current time of the clock 314 (e.g., by one millisecond, 1 second, or another granularity). Additionally or alternatively to using the clock signal from a crystal or oscillator, the processor of the clock 314 may track or count the periodic AC signal received at an AC interface (e.g., similar to AC interface 218) as described above with respect to FIG. 2. The processor of the clock 314 may then increment the current time of the clock 314 based on that tracked periodic AC signal. In some examples, the processor of the clock 314 may increment the current time of the clock 314 selectively based on the clock signal in some circumstances, and the periodic AC signal in other circumstances, as described above with respect to FIG. 2. Accordingly, the process 400 may be used to update the current time indicated by the clock 314 to an accurate (or more accurate) time, removing an error that may have accumulated since a previous setting of the time indicated by the clock 314. Accordingly, the clock 314 is configured to set a time using the time information and to maintain the time for the charger 302 by incrementing the time based on a periodic signal. The processor of the clock 314 may be a dedicated processor for the clock 314 or may be a processor of the controller 312 that performs one or more other functions of the controller 312 (e.g., controlling the charging of battery packs).

In some embodiments of the process 400, the controller 312 may then control charging of one or more of battery packs (104, 204) received by the battery pack interface 316 based on the current time of the clock 314. For example, the controller 312 may compare the current time of the clock 314 to a stored time threshold. In response to determining that the current time exceeds the time threshold, the controller 312 may control charging of the battery pack(s) by, for example, (i) beginning to charge the battery pack(s), (ii) ceasing to charge the battery pack(s), and/or (iii) adjusting a charging parameter for charging the battery pack(s) (e.g., increase or decrease a charging current, increase or decrease a maximum charge level, or the like). For example, a time threshold stored in a memory of the controller 312 may be set for 10:00 pm. The controller 312 may periodically (e.g., each time through a software loop, every 100 ms, every second, every minute, etc.) access the clock 314 to determine the current time, and then compare the current time indicated by the clock 314 to the time threshold. When the clock 314 indicates 9:59 pm, the controller 312 may determine that the time threshold is not exceeded and may, in response, take no action. One minute later, when the clock indicates 10:00 pm (or one or more seconds past 10:00 pm), the controller 312 may determine that the time threshold is exceeded and perform a charging control action to control charging of the battery pack (e.g., to start charging, stop charging, or adjust charging). Controlling the charging of a battery pack based on time of day can enable a user to ensure that a battery pack is charging during certain desired time periods (e.g., overnight when overall power demand at a location or area may be lower) and that a battery pack is fully charged by a certain time when the battery pack may be needed (e.g., start of a shift at 7:00 am).

In some embodiments, to provide this control of the charging of the battery pack(s), the controller 312 may control a power switching element (e.g., a field effect transistor or bipolar junction transistor) positioned between a power source for the power tool battery charger 302 and an output of the battery pack interface 316 to close (to permit charging), to open (to cease charging), and/or to open and close at a frequency or duty cycle to adjust a charge current up or down. For example, the charger 302 of FIG. 3 may include an AC power interface similar to the AC power interface 218 of FIG. 2. This AC power interface may include an AC/DC converter that converts received AC power (e.g., at 60 Hz, 120 V) to DC power (e.g., at 24 V, 18 V, or 12). The output of the AC/DC converter may be connected, via a power line with the power switching element, to an output (charging) terminal of the battery pack interface 316. Accordingly, controlling this power switching element to open will open a circuit between the power source (the AC power interface) and a battery pack connected to the battery pack interface 316 (to interrupt or prevent charging), and controlling this power switching element to close will close the circuit between the power source and a battery pack connected to the battery pack interface 316 (to permit charging). Further, increasing the duty cycle of a control signal controlling a power switching element may increase the percentage of time that the power switching element is closed (to permit charging) relative to the power switching element being open (to cease charging), thereby increasing the charge current over a given time period. Similarly, decreasing the duty cycle may decrease the charge current over a given time period.

FIG. 5 is a block diagram of a charger for determining time information for use in controlling charging of a power tool battery pack in accordance with an embodiment. Power tool battery charger 502 includes a controller 512, a clock 514, a battery pack interface 516, a memory 534, and one or more sensors 536. The power tool battery charger 502 is similar to that of power tool battery charger of FIGS. 2 and 3, with like elements being assigned like numbers plus 300 (relative to FIG. 2) and plus 200 (relative to FIG. 3) (e.g., the description of the controller 212 of FIG. 2 provided above similarly applies to the controller 512 of FIG. 3, except for any differences noted). The power tool battery charger 302 may similarly be configured to receive and provide charging current to at least one power tool battery pack (not shown). Other components of a power tool battery charger 502 (e.g., an AC power source, an internal battery, an input shown in FIG. 2) are not shown in FIG. 5 to simplify the illustration, but may be present in the charger 302 and function similarly as in the charger 202. Additionally, the charger 502 may include a housing (e.g., similar to the housing 104 of the charger 102 in FIG. 1) that supports and/or houses the components of the charger 502 illustrated in FIG. 5, including the sensors 536.

In some embodiments, the one or more sensors 536 generates a set of data that may be provided to the controller 512 to determine time information. The one or more sensors 536 may include a motion sensor, a light sensor, a temperature sensor, a humidity sensor, or the like, or a combination of two or more of these sensors. In some embodiments, the one or more sensors 536 may include a light sensor. The light sensor may be configured to, for example, detect and indicate ambient light and detect and indicate an approximate time of day. In some embodiments, the one or more sensors 536 may include a motion sensor to detect and indicate movement of the power tool battery charger 502. In some embodiments, the motion sensor may be, for example, an accelerometer and/or gyroscope. In an example, an accelerometer may be used to measure the rate of change of velocity over time. The motion sensor may, for example, output acceleration data to the controller 512. The acceleration data may include an indication of the measured acceleration experienced by the motion sensor and, thus, by the power tool battery charger 502. The motion of the power tool battery charger 502 may help register approximate time of day and/or typical hours of use. In some examples, the motion sensor may also include a gyroscope to minimize the errors of the accelerometer in determining the moving direction of the power tool battery charger 502. In some embodiments, the one or more sensors 536 may include a temperature sensor configured to detect and indicate a temperature in the environment where the power tool battery charger 502 is located (e.g., an indoor room, an outdoor worksite). In some embodiments, the one or more sensors 536 may include a humidity sensor configured to detect and indicate a humidity in the environment where the power tool battery charger 502 is located (e.g., an indoor room, an outdoor worksite).

In some embodiments, the one or more sensors 536 may include a sensor configured to detect and indicate when a power tool battery pack is positioned in and/or removed from the power tool battery charger 502 (e.g., battery presence). For example, the sensor(s) 536 may detect and indicate when a power tool battery pack is in contact or communication with a battery pack interface 516 and when the power tool battery pack is removed (and not in contact or communication with) the battery pack interface 516. In such embodiments, the power tool battery charger 502 may remain connected to an external power source.

In some embodiments, the one or more sensors 536 may include a sensor to detect and indicate when a user interface of the charger 502 is activated. For example, the sensor may detect and indicate when a user depresses a button, turns a knob, or flips a switch on the charger 502.

The one or more sensors 536 are coupled to the controller 512 and communicate to the controller 512 various output signals indicative of various types of data including sensed information. The sensed information may include one or more of, for example, motion data, light data, temperature data, humidity data, battery presence data, or user interface activation data respectively indicative of motion, light, temperature, humidity, data, battery presence, and user interface activation that is detected and indicated by the respective sensors. The one or more sensors 536 may, for example, transmit output signals indicative of data including the sensed information to the controller 512. The controller 512 may store the data in the memory 534 as well as the time information determined by the controller 512 based on the data from the one or more sensors 536.

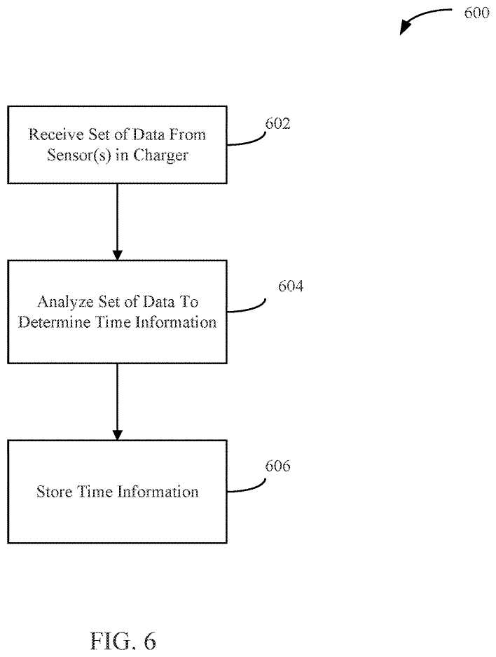

FIG. 6 illustrates a process 600 for determining time information for a charger for a power tool battery pack in accordance with an embodiment. The process 600 illustrated in FIG. 6 is described below as being carried out by the power tool battery charger 502 as illustrated in FIG. 5. However, in some embodiments, the process is implemented by another power tool battery charger having additional, fewer, and/or alternative components. Additionally, although the blocks of the process are illustrated in a particular order, in some embodiments, one or more of the blocks may be executed partially or entirely in parallel, may be executed in a different order than illustrated in FIG. 6, or may be bypassed.

In block 602, a power tool battery charger 502 receives a set of data from one or more sensors 536 in the power tool battery charger 502. In one embodiment, the one or more sensors 536 may include, for example, a light sensor configured to detect ambient light, a motion sensor to detect motion of the power tool battery charger 502, a temperature sensor to detect a temperature of the environment in which the power tool battery charger is located, a humidity sensor to detect a humidity of the environment in which the power tool battery charger is located, a sensor to detect when is positioned in and/or removed from the power tool battery charger 502, and a sensor to detect when a user interface of the charger is activated. Accordingly, the set of data may include, for example, one or more of ambient light data indicative of sensed ambient light, motion data indicative of sensed motion, temperature data indicative of sensed temperature, humidity data indicative of sensed humidity, battery presence data indicative of presence of a battery pack (or packs), and user interface activation data indicative of activation of the user interface of the charger 502. The set of data may include one or more of instantaneous data point, an average of data points over a period of time, or a collection of instantaneous and/or average data points.

In block 604, the received set of data from the one or more sensors 536 is analyzed to determine time information such as, for example, time, date, etc. The received set of data may be analyzed using, for example a controller 512 of the power tool battery charger 502. The determined time information may be, for example, an approximate time of day and/or an approximate date. In some embodiments, data from a light sensor may be used to determine an approximate time of day (e.g., based on a presumption of when sunrise and/or sunset may occur). In some embodiments, data from a motion sensor may be used to determine and track wherein the power tool battery charger moves relative to an origin point. The motion of the power tool battery charger 502 may be used to determine, for example, approximate time of day (e.g., based on a presumed work schedule) and/or typical hours of use. In some embodiments, data from a temperature sensor may be used to determine, for example, an approximate time of day. During hours of operation of the power tool battery charger 502, temperature may vary (e.g., if the power tool battery charger 502 is placed in a well ventilated and climate controlled building) and provide some indication of time. For example, temperature may rise above or fall below a temperature range when outside of a typical work hours (e.g., when HVAC usage may be reduced). Accordingly, an approximate time of day may be estimated based on detected temperature fluctuations and a presumed work schedule. In some embodiments, data from a humidity sensor may be used to determine, for example, an approximate time of day. During hours of operation of the power tool battery charger 502, humidity may vary (e.g., if the power tool battery charger 502 is placed in a well ventilated and climate controlled building) and provide some indication of time. For example, humidity may rise above or fall below a humidity range when outside of a typical work hours (e.g., when HVAC usage may be reduced). Accordingly, an approximate time of day may be estimated based on detected humidity fluctuations and a presumed work schedule. To detect these fluctuations in temperature or humidity, the controller 512 may compare sensed temperature or humidity (as the case may be) to predetermined thresholds and/or may detect peaks and valleys of the sensed temperature or humidity (as the case may be). For example, the predetermined thresholds may be stored in the memory 534 (e.g., in a configuration stage for the controller 502) or the controller 512 may detect and set (or modify) the thresholds based on observed fluctuations over one or more days. In the case of detected temperature, the controller 512 may then compare a detected temperature to a threshold and, in a warm climate, for example, determine that the current time is outside of work hours when the detected temperature is above the threshold (indicating HVAC usage is reduced) and determine that the current time is inside of work hours when the detected temperature is below the threshold (indicating HVAC usage is in normal operation). In a cold climate, the determination may be reversed such that the controller 512 determines that the current time is outside of work hours when the detected temperature is below the threshold (indicating HVAC usage is reduced) and determine that the current time is inside of work hours when the detected temperature is above the threshold (indicating HVAC usage is in normal operation). In some examples, using similar principles, the controller 512 may store and use an upper temperature (or humidity) threshold and a lower temperature (or humidity) threshold to define a range of temperatures associated with work hours (and temperatures above and below this range indicating the current time is outside of work hours). The controller 512 may further map the determined work hours to an approximate time of day. For example, in a 24-hour period, when the controller 512 determines a period of 12 work hours alternating with a period of 12 non-work hours, the controller 512 may determine that the current time at the start of a 12 work hour period to be 6:00 am. In another example, when the controller 512 determines a period of 8 work hours alternating with a period of 16 non-work hours, the controller 512 may determine the current time at the start of an 8-work hour period to be 8:00 am. The particular inference by the controller 512 based on the determined work hours may be defined by a lookup table or other mapping within the memory 534. In at least some embodiments, the particular approximated time may be arbitrary, as it may be used as a relative time point for tracking activity (e.g., typical work hours) against a 24-hour standard time period. Additionally, a date or day of the week may be inferred using similar principles, for example, to identify a weekend or holiday based on an extended period of temperature or humidity outside of a range associated with work hours.

In some embodiments, data regarding when a power tool battery pack is positioned in and/or removed from the power tool battery charger 502 may be used to determine which hours of the day see activity, for example, which hours of the day include use of the power tool battery pack to power a power tool and use of the power tool battery charger to charge the power tool battery pack. In an embodiment, the controller 512 may simply determine an estimate of the time based on when the battery pack gets put on and/or taken off of the charger 502. For example, when the controller 512 detects that the battery pack is placed and present on the charger 502 for more than a predetermined amount of time (e.g., 8 or 12 hours), the controller 512 may identify the time when the battery pack was placed on the charger 502 as the end of typical work hours, and when the controller 512 detects that the battery pack is removed from the charger 502, the controller 512 may identify the current time as the start of the typical work hours. If the power tool battery charger 502 stays plugged in for multiple days, the pattern of use defining when the batteries are put on and taken off may be enough to estimate when batteries are expected to be needed fully charged (shortly before the start of a work hours) and when to charge fast (e.g., during work hours) versus when to charge slow (e.g., when outside of work hours). For example, the charger 502 may charge a battery pack fast by using a first (higher) charging current, and may charge a battery pack slow with second (lower) charging current). In some embodiments, user interface activation data regarding when a user interface of the battery charger 502 is activated may also be used to determine which hours of the day see activity, for example, which hours of the day include use of the power tool battery pack to power a power tool and use of the power tool battery charger to charge the power tool battery pack. In an embodiment, the controller 512 may simply determine an estimate of the time based on when the user interface of the charger 502 is activated. For example, if the power tool battery charger 502 stays plugged in for multiple days, the pattern of use defining when the user interface is activated may be enough to estimate when batteries are expected to be needed fully charged and when to charge fast or slow.

In some embodiments, the power tool battery pack charger 502 includes or communicates with a machine learning controller (in any of the various forms described above). In such embodiments, the machine learning controller may analyze the received set of data from the one or more sensors 536 to determine the time information. For example, in advance of use in block 604, the machine learning controller may be trained with a training data set including sensor data (e.g., any of the sensor data described above) and corresponding time information (e.g., as labels for the sensor data). Accordingly, in block 604, the received set of sensor data may be input to the machine learning controller (e.g. by the controller 512), which, in response, may then output time information to the controller 512.

In block 606, the determined time information may be stored, for example, in a memory (e.g., the memory 534 or another memory associated with the clock 514). The stored time information may be used to, for example, set a clock 514 of the power tool battery charger 502 and to perform various functions of the power tool battery charger 502 including, for example, charging of a battery pack.

In some embodiments of the process 600, after storing the time information, the controller 312 is configured to maintain a current time for the charger 502 via the clock 514, which may be a real time clock. For example, the clock 514 may have a crystal or oscillator that generates a clock signal at regular, known intervals, which a processor of the clock 514 may track or count. Based on the tracked clock signal (e.g., after a predetermined number of rising or falling edges of the clock signal), the processor of the clock 514 may increment the current time of the clock 514 (e.g., by one millisecond, 1 second, or another granularity). Additionally or alternatively to using the clock signal from a crystal or oscillator, the processor of the clock 514 may track or count the periodic AC signal received at an AC interface (e.g., similar to AC interface 218) as described above with respect to FIG. The processor of the clock 514 may then increment the current time of the clock 514 based on that tracked periodic AC signal. In some examples, the processor of the clock 514 may increment the current time of the clock 514 selectively based on the clock signal in some circumstances, and the periodic AC signal in other circumstances, as described above with respect to FIG. 2. Accordingly, the process 600 may be used to update the current time indicated by the clock 514 to an accurate (or more accurate) time, removing an error that may have accumulated since a previous setting of the time indicated by the clock 514. Accordingly, the clock 514 is configured to set a time using the time information and to maintain the time for the charger 502 by incrementing the time based on a periodic signal. The processor of the clock 514 may be a dedicated processor for the clock 514 or may be a processor of the controller 512 that performs one or more other functions of the controller 512 (e.g., controlling the charging of battery packs).

In some embodiments of the process 600, the controller 512 may then control charging of one or more of battery packs (104, 204) received by the battery pack interface 516 based on the current time of the clock 514 (and, thus, based on the time information determined in block 602). For example, the controller 512 may compare the current time of the clock 514 to a stored time threshold. In response to determining that the current time exceeds the time threshold, the controller 512 may control charging of the battery pack(s) by, for example, (i) beginning to charge the battery pack(s), (ii) ceasing to charge the battery pack(s), and/or (iii) adjusting a charging parameter for charging the battery pack(s) (e.g., increase or decrease a charging current, increase or decrease a maximum charge level, or the like). For example, a time threshold stored in a memory of the controller 512 may be set for 10:00 pm. The controller 512 may periodically (e.g., each time through a software loop, every 100 ms, every second, every minute, etc.) access the clock 514 to determine the current time, and then compare the current time indicated by the clock 514 to the time threshold. When the clock 514 indicates 9:59 pm, the controller 514 may determine that the time threshold is not exceeded and may, in response, take no action. One minute later, when the clock indicates 10:00 pm (or one or more seconds past 10:00 pm), the controller 514 may determine that the time threshold is exceeded and perform a charging control action to control charging of the battery pack (e.g., to start charging, stop charging, or adjust charging). Controlling the charging of a battery pack based on time of day can enable a user to ensure that a battery pack is charging during certain desired time periods (e.g., overnight when overall power demand at a location or area may be lower) and that a battery pack is fully charged by a certain time when the battery pack may be needed (e.g., start of a shift at 7:00 am).

In some embodiments, the controller 514 may control a power switching element (e.g., a field effect transistor or bipolar junction transistor) positioned between a power source for the power tool battery charger 504 and an output of the battery pack interface 316 to close (to permit charging), to open (to cease charging), and/or to open and close at a frequency or duty cycle to adjust a charge current up or down. For example, the charger 502 of FIG. 5 may include an AC power interface similar to the AC power interface 218 of FIG. 2. This AC power interface may include an AC/DC converter that converts received AC power (e.g., at 60 Hz, 120 V) to DC power (e.g., at 24 V, 18 V, or 12). The output of the AC/DC converter may be connected, via a power line with the power switching element, to an output (charging) terminal of the battery pack interface 516. Accordingly, controlling this power switching element to open will open a circuit between the power source (the AC power interface) and a battery pack connected to the battery pack interface 516 (to interrupt or prevent charging), and controlling this power switching element to close will close the circuit between the power source and a battery pack connected to the battery pack interface 516 (to permit charging). Further, increasing the duty cycle of a control signal controlling a power switching element may increase the percentage of time that the power switching element is closed (to permit charging) relative to the power switching element being open (to cease charging), thereby increasing the charge current over a given time period. Similarly, decreasing the duty cycle may decrease the charge current over a given time period.

Additionally or alternatively to controlling the charging using the time information, the time information may be used to time stamp data collected by the charger 302 or the charger 502. For example, the controller 312 or 512 may collect operational data for the charger 302 or 502 and/or battery packs coupled to the charger 302 or 502 (e.g., charge cycles, charge current, discharge current, state of charge, battery pack ID of pack being charged, etc.) and may time stamp the collected operational data. The charger 302 or 502 may then analyze the time-stamped operational data and/or transmit the time-stamped operational data to an external device (e.g., the external device 206 of FIG. 2) or a server (e.g., the server 210 of FIG. 2) for analysis by another device (e.g., the external device 206 or the server 210). The charger 302 or 502 may communicate with the external device 206 and/or the server 210 using similar techniques and components as described with respect to the charger 202. The analysis of the time-stamped operational data may provide analytics information for various purposes, such as detecting trends or patterns of a single device, of a single user of multiple devices, and/or across multiple users and devices. These trends or patterns can help guide future product modifications or design parameters.

In some embodiments, a charger (e.g., the charger 202, 302, and/or 502) is provided that includes both the input 324 (e.g., with one or both of the user interface 326 and communication system 328) of the charger 302 (FIG. 3) and the sensor(s) 536 of the charger 502 (FIG. 5). Accordingly, such chargers may be configured to perform either or both of the processes 400 and 600 to determine and store time information. Such chargers may further be configured to maintain a current time and control charging based on the current time, as described above with respect to the chargers 304 and 504. In some embodiments, the charger may execute the process 400 when time information is available via the user interface 326 and/or communication system 328 (e.g., when an external time source 330 is within communication range). In some embodiments, the charger may execute the process 600 when time information is not available via the user interface 326 and/or communication system 328.

The power tool battery pack charger(s) 102, 202, 302, 502 and power tool battery pack(s) 104, 204 described above are just some examples of such chargers and packs. In some embodiments, the power tool battery pack charger(s) 102, 202, 302, 502 have another configuration. For example, the power tool battery pack charger(s) 102, 202, 302, 502 may have additional or fewer charging docks, may have a different electrical and/or mechanical interface for interfacing with a power tool battery pack, and/or may be configured to charge a different type (or combination of types) or power tool battery packs (e.g., having different capacities or nominal voltage levels). Similarly, in some embodiments, the power tool battery pack(s) 104, 204 have another configuration. For example, the power tool battery pack(s) 104, 204 may have a different electrical and/or mechanical interface for interfacing with power tools and/or power tool battery pack chargers and/or may be configured to be charged by a different type of power tool battery pack chargers, may have a different capacity, and/or may have a different nominal voltage level.

In some embodiments, one or more of the power tool battery pack charger(s) 102, 202, 302, 502 includes or communicates with a machine learning controller (in any of the various forms described above). In such embodiments, the machine learning controller may receive the time information (or current time from the clock of the particular power tool battery charger). For example, the clock (e.g., 214, 314, 514) of the particular power tool battery charger may output the current time to the machine learning controller. The machine learning controller may further control charging of power tool battery pack connected to the particular power tool battery charger based on time information or current time.

In some embodiments, a power tool device other than a charger performs the steps of the process 600. A power tool device may include, for example, a power tool, a power tool battery pack, an adapter providing an electro-mechanical interface between a power tool and a power tool battery pack, a portable power supply including an inverter and powered by one or both of power tool battery packs and internal batteries, or another device powered by a power tool battery pack. The power tool device may, like the charger 502, include a controller 512, clock 514, memory 534, and sensor(s) 536. The power tool device may further include a motor for driving a tool implement, a non-motor actuator for actuating a tool implement, an inverter for inverting DC power from one or more batteries to provide AC power output (e.g., in the case of a portable power supply), a power tool interface to interface with a power tool (e.g., in the case of a battery pack), or other additional components. With reference to FIG. 6, the power tool device may further receive a set of data from its sensor(s) 536 (block 602). The set of data may include, for example, one or more of ambient light data indicative of sensed ambient light, motion data indicative of sensed motion, temperature data indicative of sensed temperature, humidity data indicative of sensed humidity, battery presence data indicative of presence of a battery pack (or packs) (e.g., attached to a tool or portable power supply), and user interface activation data indicative of activation of the user interface of the power tool device. In block 604, the power tool device may further analyze the set of data to determine time information, using similar techniques as described above with respect to the charger 502 implementing block 604. In block 606, the power tool device may further store the time information using similar techniques as described above with respect to the charger 502 implementing block 606.

In some embodiments, after storing the time information, the controller of the power tool device is configured to maintain a current time for the power tool device. For example, the clock of the power tool device may have a crystal or oscillator that generates a clock signal at regular, known intervals, which the clock may track or count. Based on the tracked clock signal (e.g., after a predetermined number of rising or falling edges of the clock signal), the clock may increment the current time of the clock (e.g., by one millisecond, 1 second, or another granularity). In some embodiments, the controller may then control a component of the power tool device based on the stored time information. For example, the controller of the power tool device may activate, deactivate, or otherwise alter control of a motor, a non-motor actuator, and/or an inverter of the power tool device, based on the time information. For example, in some embodiments, after storing the time information, the controller may compare the current time of the clock to a stored time threshold. In response to determining that the current time exceeds the time threshold, the controller may activate, deactivate, or otherwise alter control of a motor, a non-motor actuator, and/or an inverter of the power tool device.

Additionally or alternatively to controlling a component of the power tool device using the time information, the time information may be used to time stamp data collected by the power tool device. For example, the controller of the power tool device may collect operational data for the power tool device (e.g., operation cycles, operation current, battery pack ID of pack coupled to the power tool device, etc.) and may time stamp the collected operational data. The power tool device may then analyze the time-stamped operational data and/or transmit the time-stamped operational data to an external device (e.g., the external device 206 of FIG. 2) or a server (e.g., the server 210 of FIG. 2) for analysis by another device (e.g., the external device 206 or the server 210). The power tool device may communicate with the external device 206 and/or the server 210 using similar techniques and components as described with respect to the charger 202. The analysis of the time-stamped operational data may provide analytics information for various purposes, such as detecting trends or patterns of a single device, of a single user of multiple devices, and/or across multiple users and devices. These trends or patterns can help guide future product modifications or design parameters.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A charger for determining time information for use in controlling charging of a power tool battery pack, the charger comprising:
a battery pack interface configured to receive a power tool battery pack and provide charging current to the power tool battery pack;
an input configured to receive a set of data;
a controller coupled to the input, the controller configured to analyze the set of data to determine time information;
a memory coupled to the controller and configured to store the time information;
a real time clock configured to set a time using the time information and to maintain the time; and
an internal battery coupled to the real time clock.

2. (canceled)

3. (canceled)

4. The charger according to claim 1, wherein the charger is further configured to recharge the internal battery using power received from one or more of an AC power interface of the charger when the AC power interface is connected to an AC power source or the battery pack interface when the battery pack interface is connected the power tool battery pack.

5. The charger according to claim 1, wherein the input is a communication system configured to receive the set of data from an external time source.

6. The charger according to claim 5, wherein the external time source is a power tool battery pack and the communication system is one or more communication terminals of the battery pack interface.

7. The charger according to claim 5, wherein the external time source is one or more of a power tool battery pack, a server, cellular telephone, a smartphone, a tablet, or a laptop, and the communication system is a wireless communication system.

8. The charger according to claim 5, wherein the external time source is a satellite and the communication system is a global navigation satellite system (GNSS) device.

9. The charger according to claim 1, wherein input is a user interface configured to receive the set of data from a user.

10. The charger according to claim 1, wherein the controller is further configured to:
control charging of the power tool battery pack based on the time information.

11. A method for determining time information for a charger for a power tool battery pack, the method comprising:
receiving, using an input of the charger, a set of data;
analyzing, using a controller of the charger, the set of data to determine time information;
storing the time information in a memory;
setting a time, by a real time clock, using the time information;
maintaining the time by the real time clock; and
providing power, by an internal battery of the charger, to the real time clock.

12. (canceled)

13. (canceled)

14. The method according to claim 11, further comprising:
recharging, by the charger, the internal battery using power received from one or more of an AC power interface of the charger when the AC power interface is connected to an AC power source or the battery pack interface when the battery pack interface is connected the power tool battery pack.

15. The method according to claim 11, wherein the input is a communication system and wherein receiving the set of data by the input includes receiving, by the communication system, the set of data from an external time source.

16. The method according to claim 15, wherein the external time source is a power tool battery pack and the communication system is one or more communication terminals of the battery pack interface.

17. The method according to claim 15, wherein the external time source is one or more of a power tool battery pack, a server, cellular telephone, a smartphone, a tablet, or a laptop, and the communication system is a wireless communication system.

18. The method according to claim 15, wherein the external time source is a satellite and the communication system is a global navigation satellite system (GNSS) device.

19. The method according to claim 11, wherein input is a user interface and wherein receiving the set of data by the input includes receiving, by the user interface, the set of data from a user.

20. The method according to claim 11, further comprising:
controlling, by the controller, charging of the power tool battery pack based on the time information.

21.-36. (canceled)
